(19) United States
(12) Patent Application Publication
(10) Pub. No.: US 2017/0244859 A1
(43) Pub. Date: Aug. 24, 2017

(54) COMMUNICATION APPARATUS, METHOD OF CONTROLLING COMMUNICATION APPARATUS, AND STORAGE MEDIUM

(71) Applicant: CANON KABUSHIKI KAISHA, Tokyo (JP)

(72) Inventor: Tetsuya Yamada, Matsudo-shi (JP)

(21) Appl. No.: 15/433,948

(22) Filed: Feb. 15, 2017

(30) Foreign Application Priority Data
Feb. 23, 2016 (JP) 2016-032476

(51) Int. Cl. H04N 1/327; H04N 1/44

(52) U.S. Cl. CPC H04N 1/32747; H04N 1/4433; H04N 2201/0094

(57) ABSTRACT

A mechanism in a communication apparatus configured to transmit image data if a user that checked a destination is a user having approval authority is provided. The communication apparatus receives a destination from the user, acquires identification information about the user that checked the destination, determines whether the user that checked the destination has the approval authority based on the identification information, and transmits image data to the destination based on determining that the user that checked the destination has the approval authority.

### BACKGROUND OF THE INVENTION

Field of the Invention

The aspect of the embodiments relates to a communication apparatus, a method of controlling communication apparatus, and a storage medium.

Description of the Related Art

A conventional communication apparatus configured to transmit an image, such as a facsimile apparatus, transmits image data to an unintended destination if a user designates a wrong transmission destination.

To prevent such erroneous transmission, a user that gives an instruction to transmit image data asks another user to come to the communication apparatus, and the other user as a checker visually checks details of an input transmission destination.

Further, there is a conventional technique in which facsimile transmission is executed if an input destination is transmitted to a facsimile server and the destination is checked by operating a terminal connected to the facsimile server (refer to Japanese Patent Application Laid-Open No. 2007-258946).

The user to check the transmission destination and give permission to transmit image data is desirably someone having approval authority to permit the transmission.

However, the conventional techniques do not determine whether the user that comes to the communication apparatus and checks the destination has an authority to give permission to transmit image data.

The technique discussed in Japanese Patent Application Laid-Open No. 2007-258946 is to transmit an electronic mail to an approver but does not determine whether the user that comes to the communication apparatus has an authority to approve image data.

### SUMMARY OF THE INVENTION

According to an aspect of the embodiments, a communication apparatus includes a reception unit configured to receive a destination from a user, an acquisition unit configured to acquire identification information about a user that checked the destination, a determination unit configured to determine whether the user that checked the destination has approval authority based on the identification information about the user, and a transmission unit configured to transmit image data to the destination received by the reception unit based on the determination unit determining that the user that checked the destination has the approval authority.

Further features of the disclosure will become apparent from the following description of exemplary embodiments with reference to the attached drawings.

### BRIEF DESCRIPTION OF THE DRAWINGS

FIG. 1 is a block diagram illustrating a configuration of a communication system according to an exemplary embodiment of the disclosure.

FIG. 2 illustrates an operation unit according to an exemplary embodiment of the disclosure.

FIG. 3 is a flowchart illustrating an example of control according to an exemplary embodiment of the disclosure.

FIGS. 4A, 4B, and 4C each illustrate an operation screen according to an exemplary embodiment of the disclosure.

FIGS. 5A and 5B each illustrate a database according to an exemplary embodiment of the disclosure.

FIG. 6 is a flowchart illustrating an example of control according to an exemplary embodiment of the disclosure.

FIG. 7 is a flowchart illustrating an example of control according to an exemplary embodiment of the disclosure.

FIG. 8 is a flowchart illustrating an example of control according to an exemplary embodiment of the disclosure.

FIGS. 9A, 9B, and 9C each illustrate an operation screen according to an exemplary embodiment of the disclosure.

FIGS. 10A, 10B, and 10C each illustrate an operation screen according to an exemplary embodiment of the disclosure.

FIG. 11 is a flowchart illustrating an example of control according to an exemplary embodiment of the disclosure.

FIGS. 12A, 12B, and 12C each illustrate a database according to an exemplary embodiment of the disclosure.

### DESCRIPTION OF THE EMBODIMENTS

Various exemplary embodiments of the disclosure will be described below with reference to the accompanying drawings.

The following describes a first exemplary embodiment of the disclosure.

### <System Configuration>

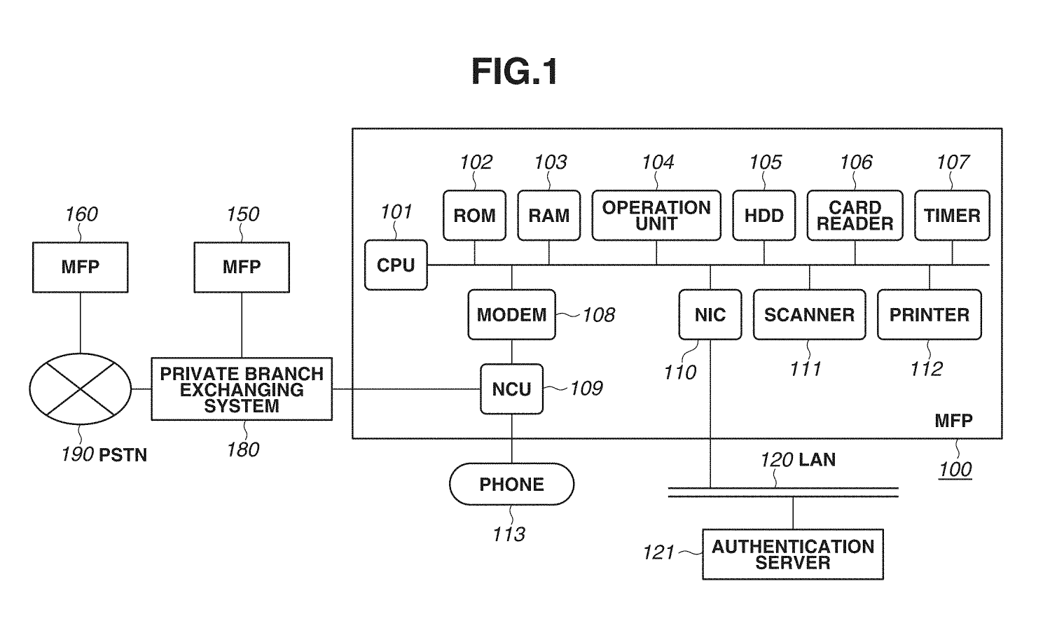

FIG. 1 is a block diagram illustrating the configuration of a communication system including a multi-function peripheral (MFP) 100, which is an example of a communication apparatus according to the present exemplary embodiment. The communication system includes the MFP 100 and an authentication server 121.

The MFP 100 according to the present exemplary embodiment includes a central processing unit (CPU) 101, a read-only memory (ROM) 102, a random access memory (RAM) 103, an operation unit 104, a hard disk drive (HDD) 105, a card reader 106, a timer 107, a modem 108, a network control unit (NCU) 109, a network interface card (NIC) 110, a scanner 111, and a printer 112.

The MFP 100 is connected to a MFP 150 via a private branch exchanging system 180 and communicates with the MFP 150 connected to an extension via the private branch exchanging system 180. Further, the MFP 100 communicates with a MFP 160 via the private branch exchanging system 180 and public switched telephone networks (PSTN) 190.

The CPU 101 reads a program stored in the ROM 102 or the HDD 105, and executes the program to comprehensively control the MFP 100.

The ROM 102 stores the program to be read and executed by the CPU 101.

The RAM 103 functions as a work area of the CPU 101. The RAM 103 stores data and the program read by the CPU 101.

The operation unit 104 includes hardware keys and a display unit including a touch panel. The operation unit 104 displays an operation screen and a status of the MFP 100 on the display unit. Further, the operation unit 104 receives user operations via the hardware keys or the touch panel.

The HDD 105 is a large-capacity non-volatile memory which stores programs and image data. In place of the HDD 105, a Blu-ray disc or a solid state drive (SSD) can be used.

The card reader 106 is an integrated circuit (IC) card reader which wirelessly reads information stored in an IC card brought close to the card reader 106 by a user. In place of the IC card reader, another method may be used in which information is read from a magnetic tape attached to a card. The card reader 106 is provided as an optional apparatus and is removable from the MFP 100.

The timer 107 manages the current time.

The modem 108 modulates/demodulates signals communicated by facsimile. The modem 108 modulates data transmitted by facsimile from the MFP 100. Further, the modem 108 demodulates data received by facsimile.

The NCU 109 transmits and receives information to and from the private branch exchanging system 180 by a predetermined procedure. For example, the NCU 109 transmits and receives dial signals for communication by the MFP 100 via the PSTN 190. The NCU 109 is connected to a PHONE 113.

The NIC 110 controls network communication performed by the MFP 100 via a local area network (LAN) 120. The MFP 100 performs network communication with the authentication server 121, a personal computer (PC) (not illustrated), or a MFP (not illustrated) via the NIC 110 and the LAN 120.

The scanner 111 reads an image of a document placed on a platen glass and generates image data of the read document image. Further, the scanner 111 can include an auto document feeder (ADF) configured to convey a plurality of documents one by one. In the case of reading documents using the ADF, the scanner 111 reads the documents conveyed by the ADF and generates image data of images of the documents. The generated image data is stored in the HDD 105.

The printer 112 feeds a sheet and prints an image on the fed sheet. A printing operation of the image is performed based on image data of the document read by the scanner 111, image data received via the NCU 109, or image data received via the LAN 120.

The configurations of the MFPs 150 and 160 are similar to the configuration of the MFP 100, so detailed descriptions thereof is omitted.

The private branch exchanging system 180 calls the PSTN 190 if the private branch exchanging system 180 receives an incoming call from the MFP 100 and an external line number is added to the head of the destination. On the other hand, the private branch exchanging system 180 calls the MFP 150 if the private branch exchanging system 180 receives an incoming call from the MFP 100 and no external line number is added to the head of the destination.

The authentication server 121 receives from the MFP 100 identification information for identifying the user input to the MFP 100, and executes user authentication based on the received identification information. If the user is successfully authenticated, the authentication server 121 transmits a notification of the successful authentication and user information to the MFP 100. While the authentication server 121 and the MFP 100 are in different housings in the present exemplary embodiment, the authentication server 121 and the MFP 100 can be integrated in a single housing.

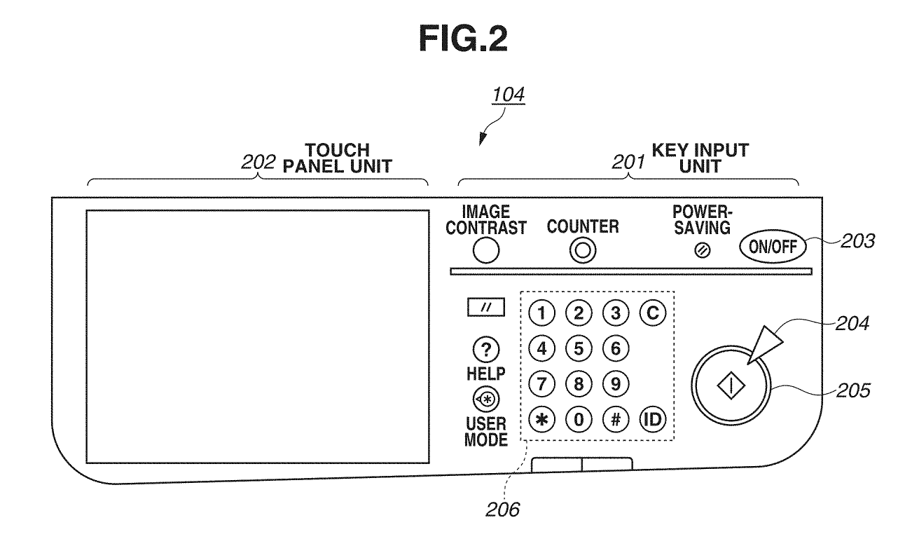

FIG. 2 illustrates the operation unit 104 illustrated in FIG. 1.

The operation unit 104 includes a key input unit 201 configured to receive user operations performed with hardware keys. Further, the operation unit 104 includes a touch panel unit 202 configured to display software keys and to receive user operations performed with the software keys.

First, the following describes the key input unit 201. As illustrated in FIG. 2, the key input unit 201 includes an operation unit power switch 203. If the operation unit power switch 203 is pressed by a user while the MFP 100 is in a standby mode (a normal operation state), the CPU 101 switches the MFP 100 from the standby mode to a sleep mode (a state in which the power consumption is lower than the power consumption in the normal operation state). On the other hand, if the operation unit power switch 203 is pressed by the user while the MFP 100 is in the sleep mode, the CPU 101 switches the MFP 100 from the sleep mode to the standby mode.

A start key 205 is a key for receiving from the user an instruction to cause the MFP 100 to execute a copy job or a transmission job.

A stop key 204 is a key for receiving from the user an instruction to interrupt a copy job or a transmission job being executed.

Numeric keys 206 are keys for receiving from the user settings of the number of copies or telephone numbers.

Next, the following describes the touch panel unit 202. The touch panel unit 202 includes a liquid crystal display (LCD) and a touch panel sheet attached on the LCD and including a transparent electrode. The LCD displays an operation screen and a status of the MFP 100. The touch panel sheet is used to receive user operations with the operation screen displayed on the LCD.

The user inputs a destination by operating the operation unit 104 and requests execution of a transmission job by pressing the start key 205. There are various transmission jobs. In one transmission job, image data generated by reading an image of a document with the scanner 111 is attached to an electronic mail and transmitted via the LAN 120. In another, image data generated by reading an image of a document with the scanner 111 is transmitted by facsimile via the NCU 109. In the present exemplary embodiment, the facsimile transmission will be described as an example of the transmission job.

If the MFP 100 receives a facsimile transmission instruction, the MFP 100 causes the scanner 111 to read an image of a document and transmits by facsimile via the NCU 109 image data generated by the scanner 111 by reading the document.

At this time, if a destination input by the user is incorrect, the image data is transmitted to an unintended destination.

Thus, a user as a checker different from the user as a transmitter checks the destination input to the MFP 100 according to the present exemplary embodiment. Then, the checker inputs checker identification information to the MFP 100. If the checker identification information is input, the MFP 100 executes transmission of the image data.

In this way, erroneous transmission can be prevented.

The following describes the processing in detail.

### <Login Processing>

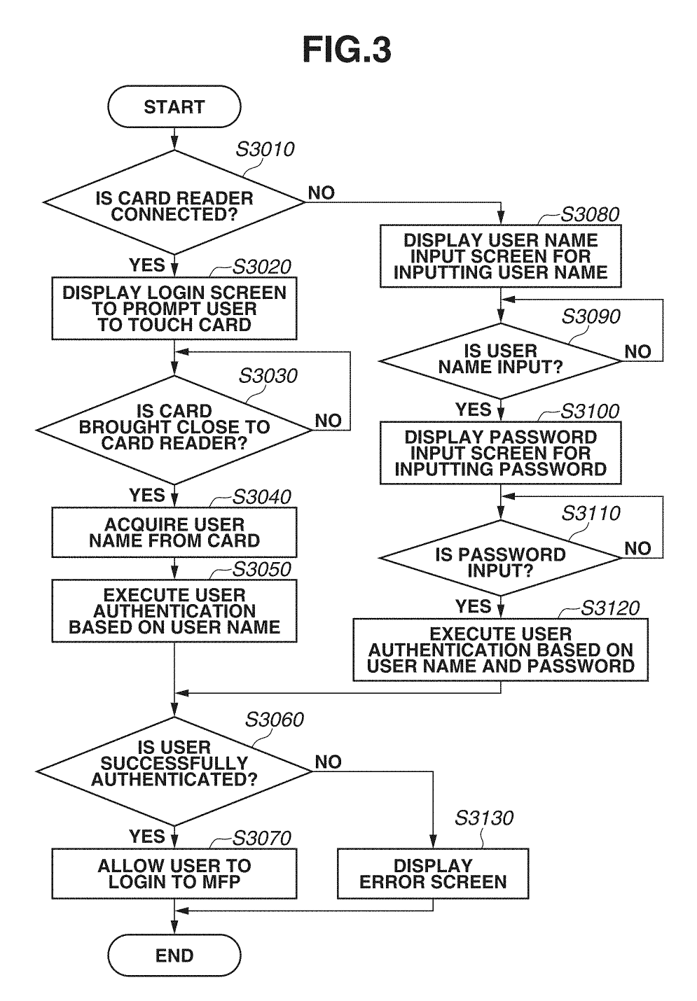

First, the following describes login processing for allowing a transmitter to log in to the MFP 100 with reference to FIG. 3. The CPU 101 reads a program stored in the ROM 102 into the RAM 103 and executes the program to realize a process illustrated in a flowchart in FIG. 3.

The process illustrated in the flowchart in FIG. 3 starts when the MFP 100 is activated or when the user logs out from the MFP 100.

In step S3010, the CPU 101 determines whether the card reader 106 is connected to the MFP 100. If the CPU 101 determines that the card reader 106 is connected (YES in step S3010), the processing proceeds to step S3020. On the other hand, if the CPU 101 determines that the card reader 106 is not connected (NO in step S3010), the processing proceeds to step S3080.

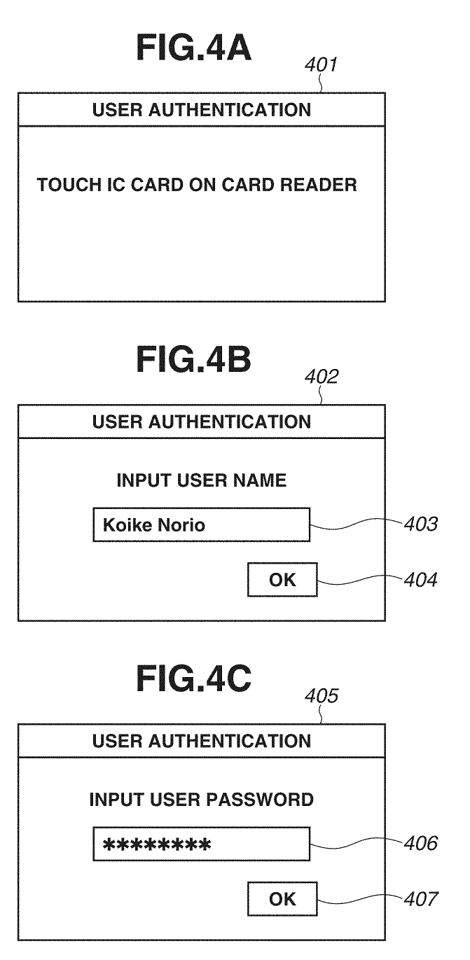

In step S3020, the CPU 101 displays on the operation unit 104 a login screen to prompt the user to touch a card. FIG. 4A illustrates an example of the login screen. A login screen 401 displays a message, “Touch the IC card on the card reader”.

In step S3030, the CPU 101 determines whether the IC card is brought close to the card reader 106. A contactless IC card can be used as the IC card. If the IC card is brought close to the card reader 106 and the distance between the IC card and the card reader 106 becomes a predetermined distance, wireless communication is performed between an IC chip in the IC card and the card reader 106. If the wireless communication is detected by the card reader 106, the card reader 106 notifies the CPU 101 that the wireless communication is performed, and the CPU 101 determines that the IC card is brought close to the card reader 106. The CPU 101 repeats step S3030 until the IC card is brought close to the card reader 106. If the CPU 101 determines that the IC card is brought close to the card reader 106 (YES in step S3030), the processing proceeds to step S3040.

In step S3040, the CPU 101 performs wireless communication with the IC card brought close to the card reader 106, acquires from the IC card a user name stored in the IC card, and stores the acquired user name in the RAM 103.

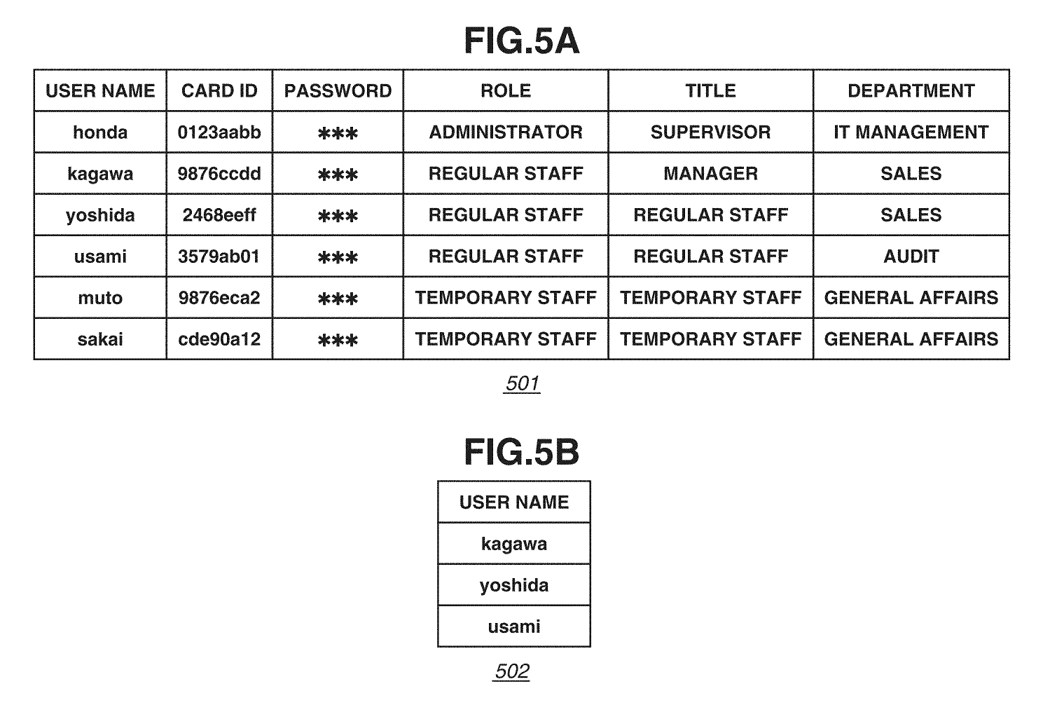

In step S3050, the CPU 101 executes user authentication based on the user name acquired in step S3040. Specifically, the CPU 101 executes user authentication by determining whether the user name acquired in step S3040 is registered in a user database 501 illustrated in FIG. 5A. The user database 501 is stored in the HDD 105, and the CPU 101 refers to the user database 501. The user database 501 includes the user name (user identification (ID)), a card ID, a password, a role, a title, and a department. The password is encrypted and stored. The encrypted password is decrypted when it is read. Information other than the password can also be encrypted and stored in the HDD 105.

The user is successfully authenticated if the user name acquired and stored in the RAM 103 in step S3040 is registered in the user database 501. On the other hand, the user is unsuccessfully authenticated if the user name acquired and stored in the RAM 103 in step S3040 is not registered in the user database 501.

On the other hand, in the case where the processing proceeds from step S3010 to S3080, in step S3080, the CPU 101 displays on the operation unit 104 a user name input screen for inputting the user name. FIG. 4B illustrates an example of the user name input screen. A user name input screen 402 displays the message, “Input the user name”, a user name input region 403, and an OK button 404. If the user name input region 403 is selected by the user, a software keyboard for inputting characters and numbers is displayed, and the user inputs the user name via the software keyboard.

In step S3090, the CPU 101 determines whether the user name is input. The CPU 101 repeats step S3090 until the OK button 404 is pressed. If the OK button 404 is pressed (YES in step S3090), the CPU 101 stores in the RAM 103 the user name input to the user name input region 403, and the processing proceeds to step S3100.

In step S3100, the CPU 101 displays on the operation unit 104 a password input screen for inputting the password. FIG. 4C illustrates an example of the password input screen. A password input screen 405 includes the message, “Input the user password”, a password input region 406, and an OK button 407. If the password input region 406 is selected by the user, the software keyboard for inputting characters and numbers is displayed, and the user inputs the password via the software keyboard.

In step S3110, the CPU 101 determines whether the password is input. The CPU 101 repeats step S3110 until the OK button 407 is pressed. If the OK button 407 is pressed (YES in step S3110), the CPU 101 stores the input password in the RAM 103, and the processing proceeds to step S3120.

In step S3120, the CPU 101 executes user authentication based on the user name and password stored in the RAM 103. Specifically, the CPU 101 executes user authentication by determining whether the user name and password stored in the RAM 103 are registered in the user database 501 illustrated in FIG. 5A. The user is successfully authenticated if the user name and password stored in the RAM 103 are registered in the user database 501. On the other hand, the user is unsuccessfully authenticated if the user name and password stored in the RAM 103 are not registered in the user database 501.

In step S3060, the CPU 101 determines whether the user is successfully authenticated. If the CPU 101 determines that the user is successfully authenticated (YES in step S3060), the processing proceeds to step S3070. On the other hand, if the CPU 101 determines that the user is unsuccessfully authenticated (NO in step S3060), the processing proceeds to step S3130.

In step S3070, the CPU 101 allows the authenticated user to log in to the MFP 100 to use the MFP 100. Then, the CPU 101 displays a job setting screen on the operation unit 104.

On the other hand, in the case where the processing proceeds from step S3060 to S3130, in step S3130, the CPU 101 displays on the operation unit 104 an error screen indicating that the authentication is unsuccessful.

The foregoing describes the login processing.

While FIG. 3 illustrates the example in which the login processing is executed in the MFP 100, the login processing can be performed using the authentication server 121. In this case, the CPU 101 of the MFP 100 transmits to the authentication server 121 the user name acquired in step S3040, or the user name acquired in step S3090 and the password acquired in step S3110, and the authentication server 121 executes step S3050 or S3120. Then, the authentication server 121 transmits a result of the authentication to the MFP 100.

### <Execution of Transmission Job and Storage of Transmission History>

After logging in to the MFP 100, the user sets transmission job settings via a displayed job setting screen. The job setting screen for setting the transmission job settings can be displayed immediately after the login to the MFP 100, or the job setting screen can be displayed if a transmission function is selected on a function selection screen after the login to the MFP 100.

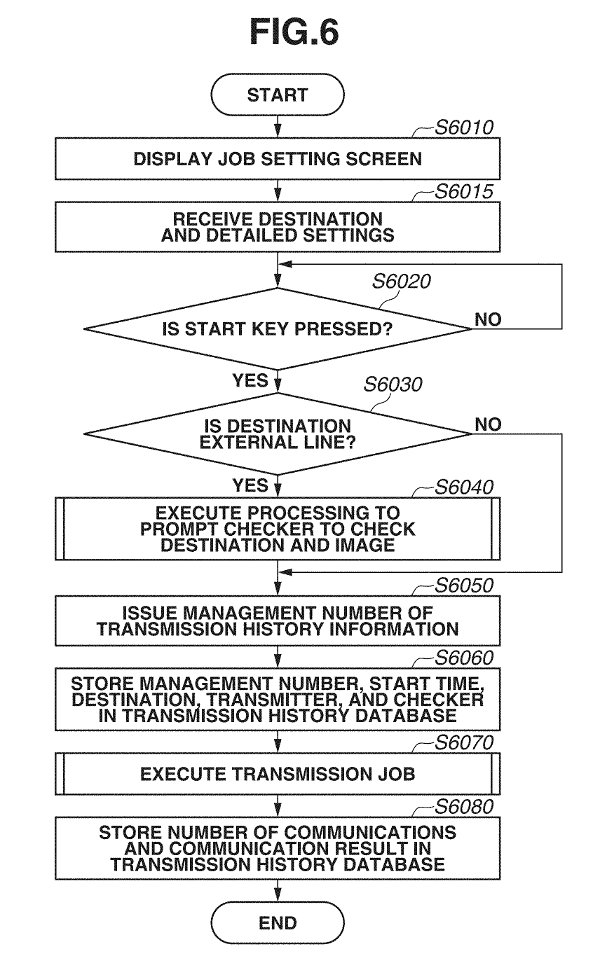

FIG. 6 is a flowchart illustrating a process from the execution of a transmission job to the storage of history information about the transmission job, which is performed after the user logs in to the MFP 100. The CPU 101 reads a program stored in the ROM 102 into the RAM 103 and executes the program to realize the process specified in the flowchart illustrated in FIG. 6.

In step S6010, the CPU 101 displays the job setting screen on the operation unit 104. The MFP 100 can display the job setting screen for setting copy job settings, the job setting screen for setting an electronic mail transmission job, the job setting screen for setting facsimile transmission job settings, etc. In the present exemplary embodiment, the processing which is performed after the job setting screen for setting the facsimile transmission job settings is displayed will be described.

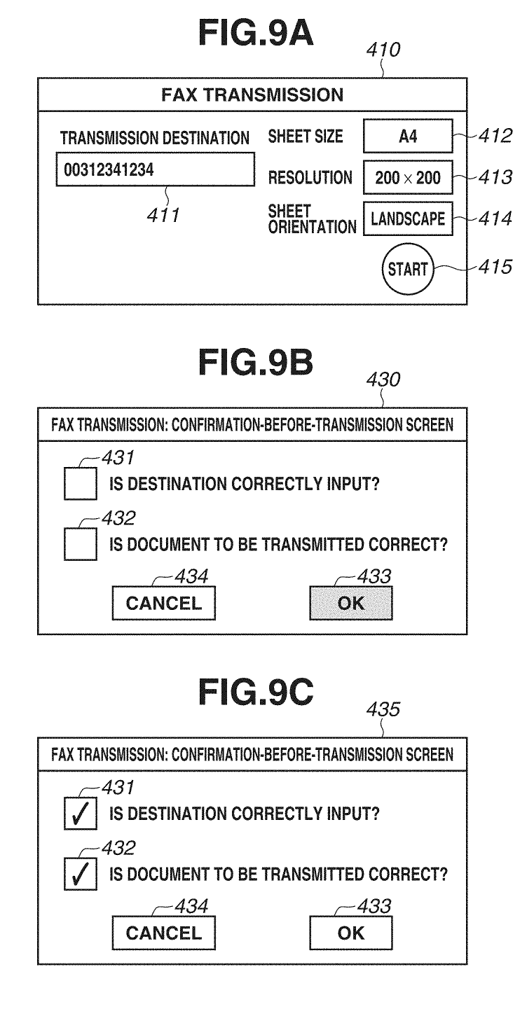

In step S6015, the CPU 101 receives a destination and detailed settings via the job setting screen. FIG. 9A illustrates an example of the job setting screen. A job setting screen 410 is a transmission job setting screen. The transmission job setting screen includes a destination input region 411, a sheet size setting region 412, a resolution setting region 413, a sheet orientation setting region 414, and a start key 415. The destination input region 411 is a region for setting a transmission destination of image data by the user. The sheet size setting region 412 is a setting region for setting the size of a sheet to be used at the destination. The resolution setting region 413 is a setting region for setting the transmission resolution of image data. The sheet orientation setting region 414 is a setting region for setting the orientation of a sheet to be used at the destination.

The user inputs the destination by touching the destination input region 411 and operating the numeric keys 206. Further, the user changes the detailed settings when needed. For example, the user changes the resolution setting region 413 from 200 dpi×200 dpi to 400 dpi×400 dpi. The changed contents are stored in the HDD 105 by the CPU 101. The detailed settings are not limited to those illustrated in FIG. 9A and can include other settings such as switching between memory transmission and direct transmission.

In step S6020, the CPU 101 determines whether the start key 205, which is a hardware key, or the start key 415, which is a software key, is pressed. The CPU 101 repeats step S6020 until either one of the start keys 205 and 415 is pressed. If the start key 205 or 415 is pressed (YES in step S6020), the CPU 101 determines that a transmission request is received, and the processing proceeds to step S6030.

In step S6030, the CPU 101 determines whether the destination input to the destination input region 411 is an external line or an extension. In a case of calling an external line, a destination generally starts with “00” which is a combination of “0” of an external line calling number and “0” at the beginning of an area code. Thus, if the destination input to the destination input region 411 starts with “00”, the CPU 101 determines that the destination is an external line. On the other hand, if the destination input to the destination input region 411 starts with a number other than “00”, the CPU 101 determines that the destination is an extension. Alternatively, the CPU 101 can determine that the input destination is an external line if the number of digits of the destination is larger than a predetermined number of digits, and the CPU 101 can determine that the input destination is an extension if the number of digits of the destination is smaller than the predetermined number of digits. If the CPU 101 determines that the destination input to the destination input region 411 is an external line (YES in step S6030), the processing proceeds to step S6040. On the other hand, if the CPU 101 determines that the destination input to the destination input region 411 is an extension (NO in step S6030), step S6040 is skipped, and the processing proceeds to step S6050.

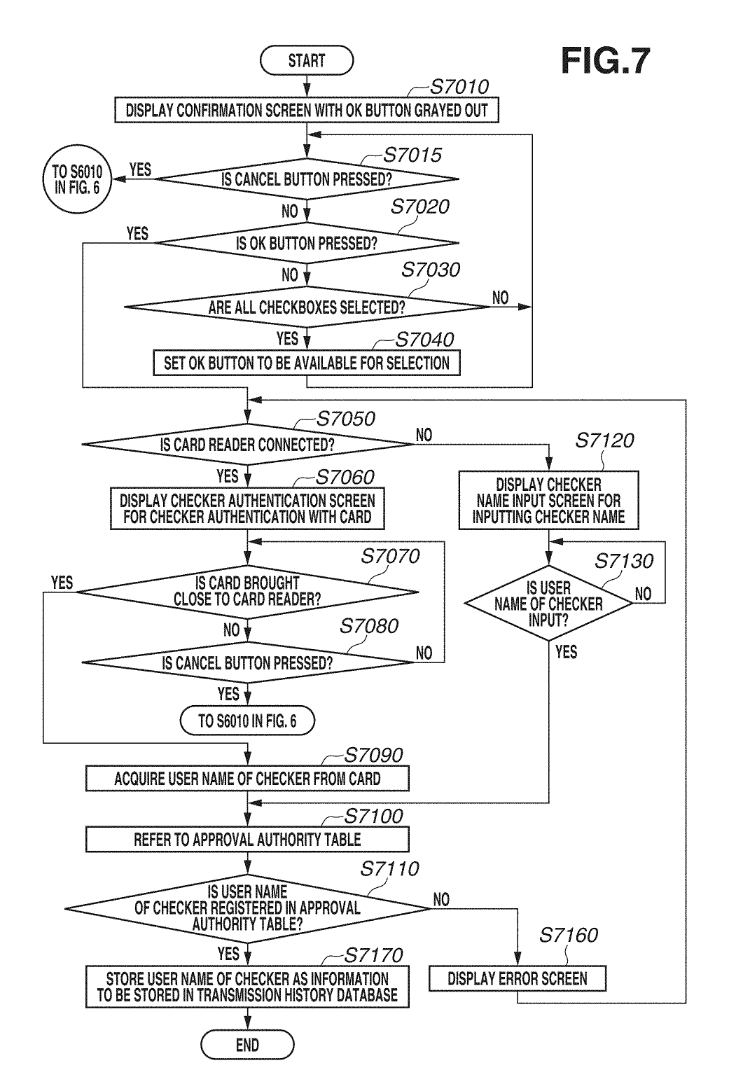

In step S6040, the CPU 101 executes processing to prompt the checker to check the destination and the image to be transmitted. The following describes details of the processing performed in step S6040 with reference to a flowchart illustrated in FIG. 7. The CPU 101 reads a program stored in the ROM 102 into the RAM 103 and executes the program to realize a process illustrated in the flowchart in FIG. 7.

In step S7010, the CPU 101 displays on the operation unit 104 a confirmation screen illustrated in FIG. 9B. FIG. 9B illustrates an example of the confirmation screen. A confirmation screen 430 is a screen for prompting the checker to check a destination and an image.

The confirmation screen 430 includes checkboxes 431 and 432. Further, the confirmation screen 430 includes an OK button 433 and a cancel button 434. In an initial state, neither one of the checkboxes 431 and 432 is checked. The OK button 433 is grayed out on the confirmation screen 430 and is not available for selection. The checker selects the checkboxes 431 if the checker confirms that the destination input by a transmitter is correct. If the checkbox 431 is selected, the CPU 101 displays a check mark in the checkbox 431. Further, if the checker confirms that the document set in the scanner 111 by the transmitter is a correct document, the checker selects the checkbox 432. If the checkbox 432 is selected, the CPU 101 displays a check mark in the checkbox 432. In this way, the checker confirms that each of the foregoing items is checked.

In step S7015, the CPU 101 determines whether the cancel button 434 is pressed. If the CPU 101 determines that the cancel button 434 is pressed (YES in step S7015), the processing proceeds to step S6010 in FIG. 6. On the other hand, if the CPU 101 determines that the cancel button 434 is not pressed (NO in step S7015), the processing proceeds to step S7020.

In step S7020, the CPU 101 determines whether the OK button 433 is pressed. If the OK button 433 is not pressed (NO in step S7020), the processing proceeds to step S7030. On the other hand, if the OK button 433 is pressed (YES in step S7020), the processing proceeds to step S7050.

In step S7030, the CPU 101 determines whether all the checkboxes are selected. If the CPU 101 determines that all the checkboxes are selected (YES in step S7030), the processing proceeds to step S7040. On the other hand, if the CPU 101 determines that not all the checkboxes are selected (NO in step S7030), the processing proceeds to step S7015.

In step S7040, the CPU 101 sets the OK button 433 to be available for selection. FIG. 9C illustrates the confirmation screen displayed on the operation unit 104 at this time. Then, the processing proceeds to step S7015. As described above, in the present exemplary embodiment, an inquiry is made to the checker as to whether the checker checks that the destination is correct and the document to be transmitted is correct, and the confirmation screen is not changed to the next screen to prohibit transmission of the image data until an indication that the destination and the document are checked is provided via the checkboxes. This prevents the checker from forgetting to check the destination and the document.

In the case where the processing proceeds from step S7020 to S7050, in step S7050, the CPU 101 determines whether the card reader 106 is connected to the MFP 100. If the CPU 101 determines that the card reader 106 is connected to the MFP 100 (YES in step S7050), the processing proceeds to step S7060. On the other hand, if the CPU 101 determines that the card reader 106 is not connected to the MFP 100 (NO in step S7050), the processing proceeds to step S7120.

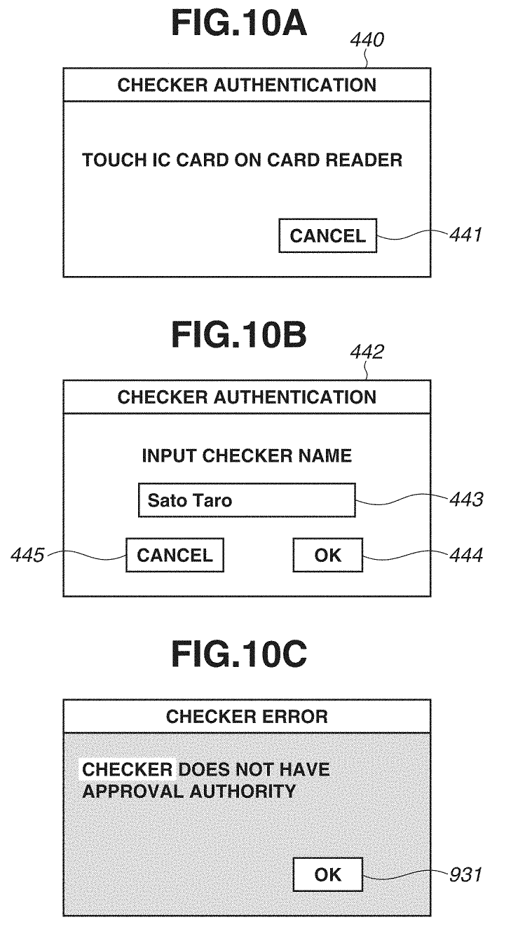

In step S7060, the CPU 101 displays on the operation unit 104 a checker authentication screen illustrated in FIG. 10A. FIG. 10A illustrates an example of the checker authentication screen. A checker authentication screen 440 includes a cancel button 441. The checker sees the checker authentication screen and brings the IC card held by the checker close to the card reader 106.

In step S7070, the CPU 101 determines whether the card is brought close to the card reader 106. A method for the determination is similar to the method used in step S3030. If the CPU 101 determines that the card is not brought close to the card reader 106 (NO in step S7070), the processing proceeds to step S7080. On the other hand, if the CPU 101 determines that the card is brought close to the card reader 106 (YES in step S7070), the processing proceeds to step S7090.

In step S7080, the CPU 101 determines whether the cancel button 441 in FIG. 10A is pressed. If the CPU 101 determines that the cancel button 441 is not pressed (NO in step S7080), the processing proceeds to step S7070. On the other hand, if the CPU 101 determines that the cancel button 441 is pressed (YES in step S7080), the processing proceeds to step S6010 in FIG. 6. At this time, the CPU 101 can cancel the set destination and detailed settings, and reset the destination and detailed settings to default values, or the CPU 101 can retain the set destination and detailed settings instead of cancelling them and can receive a change to the settings.

In step S7090, the CPU 101 performs wireless communication with the IC card brought close to the card reader 106, acquires from the IC card the user name (checker name) of the checker which is stored in the IC card, and stores the acquired user name in the RAM 103.

The foregoing describes the checker identification information acquisition method using the IC card.

On the other hand, in the case where the processing proceeds from step S7050 to S7120, in step S7120, the CPU 101 displays on the operation unit 104 a checker name input screen illustrated in FIG. 10B. A checker name input screen 442 includes a checker name input region 443, an OK button 444, and a cancel button 445. If the checker name input region 443 is selected by the user, a software keyboard for inputting characters and numbers is displayed, and the user inputs the user name via the software keyboard.

In step S7130, the CPU 101 determines whether the user name of the checker is input. The CPU 101 determines that the user name of the checker is input if the OK button 444 is selected. The CPU 101 repeats step S7130 until the user name of the checker is input. If the CPU 101 determines that the user name of the checker is input (YES in step S7130), the processing proceeds to step S7100. If the cancel button 445 is pressed, the processing can proceed to step S6010 in FIG. 6.

In step S7100, the CPU 101 refers to an approval authority table 502 illustrated in FIG. 5B. The approval authority table 502 stores user names of checkers having the authority to check a destination of data and permit transmission of the data.

In step S7110, the CPU 101 determines whether the user name of the checker is registered in the approval authority table 502 based on the approval authority table 502 to which the CPU 101 refers. If the CPU 101 determines that the user name of the checker is registered in the approval authority table 502 (YES in step S7110), the processing proceeds to step S7170. On the other hand, if the CPU 101 determines that the user name of the checker is not registered in the approval authority table 502 (NO in step S7110), the processing proceeds to step S7160.

In step S7170, the CPU 101 stores in the HDD 105 the user name of the checker as information to be stored in a transmission history database. Thereafter, the processing proceeds to step S6050 in FIG. 6.

In the case where the processing proceeds from step S7110 to S7160, in step S7160, the CPU 101 displays on the operation unit 104 an error screen illustrated in FIG. 10C which indicates that the checker is not an authorized checker. If an OK button 931 in FIG. 10C is selected, the processing proceeds to step S7050.

The following is a continuation of the description of FIG. 6. In step S6050, the CPU 101 issues a management number to add to the transmission history database a transmission history record of a new transmission job to be executed, and stores the issued management number in the transmission history database. The items in the transmission history database include the start time, a destination, a transmitter, a checker, the number of communications, and a communication result, besides the management number.

In step S6060, the CPU 101 stores in the transmission history database the management number issued in step S6050, and stores in the transmission history database the start time, a destination, a transmitter, and a checker of the transmission job that are fixed at this point in association with the management number. Specifically, the CPU 101 acquires the current time from the timer 107 and stores the acquired current time in the row of the start time in association with the management number issued in step S6050. The CPU 101 acquires the destination set in step S6015 and stores the acquired destination in association with the management number issued in step S6050. The CPU 101 stores the user name of the transmitter authenticated in step S3050 or S3120 in FIG. 3 in association with the management number issued in step S6050. The CPU 101 stores the user name of the checker which is stored in step S7170, in association with the management number issued in step S6050. The foregoing pieces of information are information fixed before the reading of the document and, therefore, can be stored in the transmission history database at this point.

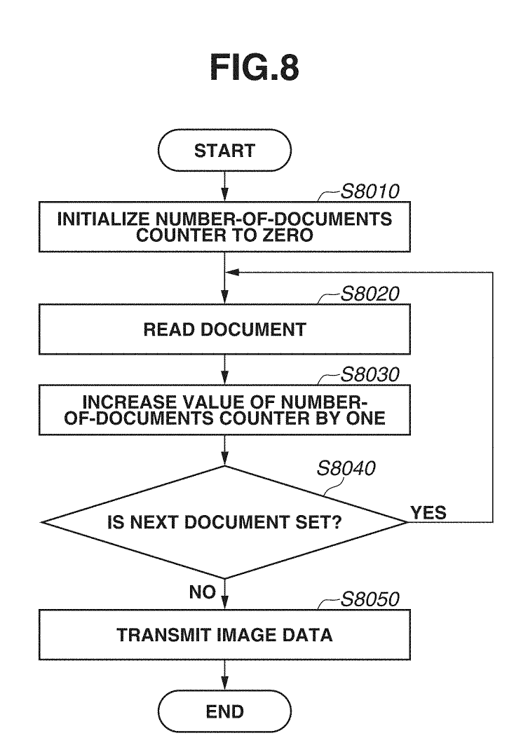

In step S6070, the CPU 101 executes the transmission job. The following describes details of step S6070 with reference to FIG. 8. The CPU 101 reads a program stored in the ROM 102 into the RAM 103 and executes the program to realize a process illustrated in a flowchart in FIG. 8.

In step S8010, the CPU 101 prepares in the RAM 103 a number-of-documents counter (variable) for counting the number of documents, and initializes the value of the number-of-documents counter to zero.

In step S8020, the CPU 101 instructs the scanner 111 to read the document according to the set detailed settings. In accordance with the instruction, the scanner 111 starts conveying the first document set in the ADF, reads an image of the conveyed document, and generates image data of the read image of the document. The CPU 101 stores the generated image data in the HDD 105.

In step S8030, the CPU 101 increases by one the value of the number-of-documents counter which is held in the RAM 103, in order to count the number of documents.

In step S8040, the CPU 101 determines whether a next document is set in the ADF using a document detection sensor provided to the ADF. If the CPU 101 determines that there is a next document in the ADF (YES in step S8040), the processing proceeds to step S8020. On the other hand, if the CPU 101 determines that there is no next document in the ADF (NO in step S8040), the processing proceeds to step S8050.

In step S8050, the CPU 101 transmits the image data stored in the HDD 105 to the destination input in step S6015 via the modem 108 and the NCU 109.

While the memory transmission is described in the present exemplary embodiment as an example in which image data of the first document is transmitted after all documents are read, an exemplary embodiment of the disclosure is not limited to the memory transmission, and direct transmission can be employed in which one document is read and transmitted and then the next document is read and transmitted.

The following is a continuation of the description of FIG. 6. In step S6080, the CPU 101 stores in the transmission history database the value of the number-of-documents counter in the RAM 103 which is counted in step S8030 as the number of communications in association with the management number issued in step S6050. Further, the CPU 101 stores the communication result in the row of the communication result in association with the management number issued in step S6050. In the communication result, “OK” is stored if the transmission of an image of the last document is completed without an error, whereas “NG” is stored if an error occurs before the transmission of the image of the last document is completed.

By the foregoing procedure, the transmission job is executed and the transmission history is stored in the HDD 105. The transmission history stored in the HDD 105 can be displayed afterward on the operation unit 104 if a display instruction is received from the user. Further, the printer 112 can perform printing if a print instruction is received from the user.

The exemplary embodiment described above allows transmission of image data if the user that checked the destination is a user having the approval authority.

In the above-described first exemplary embodiment, the example is described in which the checkers having the approval authority are managed in the approval authority table based on the user names. In a second exemplary embodiment, an example in which the checkers having the approval authority are managed based on titles will be described.

The configurations of the MFP 100 and the communication system are similar to those in the first exemplary embodiment, so descriptions thereof is omitted, and only differences will be described.

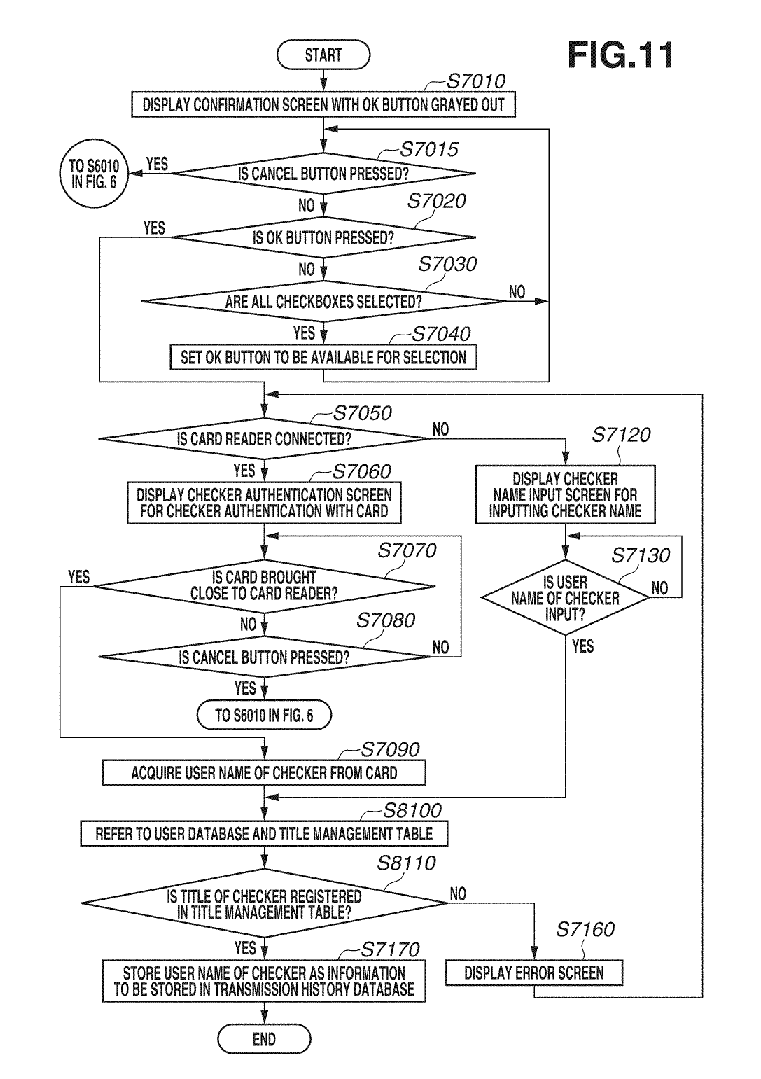

FIG. 11 is a flowchart illustrating a process according to the second exemplary embodiment. The CPU 101 reads a program stored in the ROM 102 into the RAM 103 and executes the program to realize the process specified in the flowchart illustrated in FIG. 11.

In the second exemplary embodiment, the process specified in the flowchart illustrated in FIG. 11 is executed in place of the process specified in the flowchart illustrated in FIG. 7 according to the first exemplary embodiment.

The differences are steps S8100 and S8110.

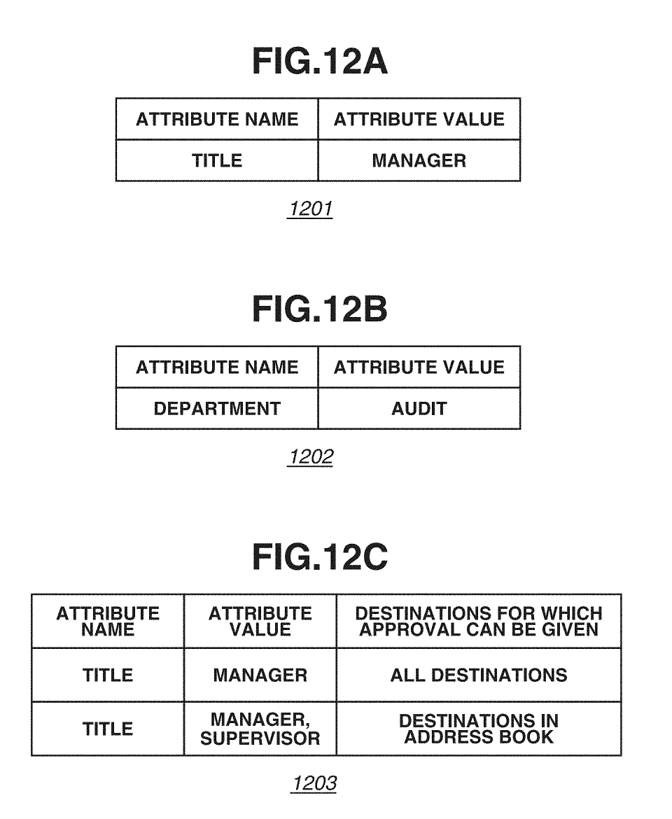

In step S8100, the CPU 101 refers to the user database 501 illustrated in FIG. 5A and a title management table 1201 illustrated in FIG. 12A.

In step S8110, the CPU 101 identifies from the user database 501 illustrated in FIG. 5A a record of a checker corresponding to the user name of the checker which is acquired in step S7080 or S7130. Then, the CPU 101 acquires a title of the checker and determines whether the acquired title is registered in the title management table 1201 illustrated in FIG. 12A. If the CPU 101 determines that the title of the checker is registered in the title management table 1201 illustrated in FIG. 12A (YES in step S8110), the processing proceeds to step S7170. On the other hand, if the CPU 101 determines that the title of the checker is not registered in the title management table 1201 illustrated in FIG. 12A (NO in step S8110), the processing proceeds to step S7160.

According to the exemplary embodiment described above, transmission of data is permitted if the user that checked the transmission destination of the data has a title having the approval authority to permit transmission of the data.

The above-described exemplary embodiment enables the authority to permit data transmission to be managed for each title.

In the above-described exemplary embodiment, whether the checker has the approval authority to permit data transmission is determined using the title management table 1201 illustrated in FIG. 12A. However, an exemplary embodiment of the disclosure is not limited to the foregoing. Whether the checker has the approval authority to permit data transmission can be determined using a department management table 1202 illustrated in FIG. 12B. In this case, in step S8100, the CPU 101 refers to the user database 501 illustrated in FIG. 5A and the department management table 1202 illustrated in FIG. 12B.

In step S8110, the CPU 101 identifies from the user database 501 in FIG. 5A a record of the checker corresponding to the user name of the checker which is acquired in step S7080 or S7130. Then, the CPU 101 acquires a department of the checker and determines whether the acquired department is registered in the department management table 1202 in FIG. 12B. If the CPU 101 determines that the department of the checker is registered in the department management table 1202 in FIG. 12B (YES in step S8110), the processing proceeds to step S7170. On the other hand, if the CPU 101 determines that the department of the checker is not registered in the department management table 1202 in FIG. 12B (NO in step S8110), the processing proceeds to step S7160.

The exemplary embodiment described above allows transmission of image data if the user that checked the destination is a user belonging to the department to which the approval authority to permit data transmission is given. The above-described exemplary embodiment enables the authority to permit data transmission to be managed for each department.

Both the title management table 1201 in FIG. 12A and the department management table 1202 in FIG. 12B can be used. In this case, in step S8110, the CPU 101 determines whether the title of the checker is registered in the title management table 1201 in FIG. 12A or the department of the checker is registered in the department management table 1202 in FIG. 12B.

In a third exemplary embodiment, an example will be described in which the title or the department having the authority to check the destination is changed depending on whether the destination is set using an address book or the destination is set by input of a new destination without the use of the address book.

The configurations of the MFP 100 and the communication system are similar to those in the first exemplary embodiment, so descriptions thereof is omitted, and only a difference will be described.

The CPU 101 determines whether the destination set in step S6015 is set using the address book or by input of a new destination.

If the destination is set using the address book, then in step S7110, the CPU 101 identifies a record that “destinations for which approval can be given” are “destinations in address book” in a title management table 1203 in FIG. 12C. Then, the CPU 101 acquires “manager, supervisor” stored as an attribute value of the record, and determines whether the title of the checker is “manager” or “supervisor”. If the title of the checker is a “manager” or a “supervisor” (YES in step S7110), the processing proceeds to step S7170. On the other hand, if the title of the checker is neither “manager” nor “supervisor” (NO in step S7110), the processing proceeds to step S7160.

On the other hand, if the destination is set by input of a new destination, then in step S7110, the CPU 101 identifies a record that “destinations for which approval can be given” are “all destinations” in the title management table 1203 in FIG. 12C. Then, the CPU 101 acquires “manager” stored as the attribute value of the record, and determines whether the title of the checker is “manager”. If the CPU 101 determines that the title of the checker is “manager” (YES in step S7110), the processing proceeds to step S7170. On the other hand, if the CPU 101 determines that the title of the checker is not “manager” (NO in step S7110), the processing proceeds to step S7160.

Specifically, a user with the title “supervisor” has the authority to check a destination set using the address book and permit data transmission, but does not have the authority to check a destination set by input of the new destination and permit data transmission.

In this way, the title or the department having the authority to check the destination can be changed depending on whether the destination is set using an address book or the destination is set by input of a new destination without the use of the address book.

While the facsimile transmission job is described in the above-described exemplary embodiment, an exemplary embodiment of the disclosure is also applicable to a transmission job of transmitting an electronic mail. In this case, the destination is not a phone number but an electronic mail address. In the case of the electronic mail, the determination in step S6030 as to whether the destination is an external line or extension is skipped.

Further, in the above-described exemplary embodiment, the CPU 101 can determine whether the user name of the checker which is acquired from the IC card is registered in the user database 501 in FIG. 5A. If the CPU 101 determines that the user name of the checker which is acquired from the IC card is registered in the user database 501 in FIG. 5A, step S7100 or S8100 can be executed. On the other hand, if the CPU 101 determines that the user name of the checker which is acquired from the IC card is not registered in the user database 501 in FIG. 5A, step S7160 is executed.

While the example in which only the user name of the checker is input via the keyboard is described in the above-described exemplary embodiment, a password can be input in addition to the user name of the checker. Then, the CPU 101 can determine whether the input user name and password of the checker are registered in the user database 501 in FIG. 5A. If the CPU 101 determines that the input user name and password of the checker are registered in the user database 501 in FIG. 5A, step S7100 or S8100 can be executed. On the other hand, if the CPU 101 determines that the input user name and password of the checker are not registered in the user database 501 in FIG. 5A, step S7160 is executed.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2016-032476, filed Feb. 23, 2016, which is hereby incorporated by reference herein in its entirety.

What is claimed is:

1. A communication apparatus comprising:
a reception unit configured to receive a destination from a user;
an acquisition unit configured to acquire identification information about a user that checked the destination;
a determination unit configured to determine whether the user that checked the destination has approval authority based on the identification information about the user; and
a transmission unit configured to transmit image data to the destination received by the reception unit based on the determination unit determining that the user that checked the destination has the approval authority.

2. The communication apparatus according to claim 1, further comprising a storage unit configured to store identification information about the user having the approval authority,
wherein the determination unit determines whether the user that checked the destination has the approval authority, based on the acquired identification information about the user and the identification information about the user which is stored in the storage unit.

3. The communication apparatus according to claim 1, further comprising:
a holding unit configured to hold a title of a user having the approval authority; and
an identification unit configured to identify, based on the identification information about the user which has been acquired by the acquisition unit, a title of the user,
wherein the determination unit determines whether the user that checked the destination has the approval authority based on the title identified by the identification unit and the title held in the holding unit.

4. The communication apparatus according to claim 3, wherein the reception unit is configured to receive the destination using an address book, and
wherein the holding unit holds a title as the title of the user having the approval authority, the title being different between a case where the reception unit receives the destination using the address book and a case where the reception unit receives the destination without using the address book.

5. The communication apparatus according to claim 1, further comprising a display unit configured to display an error based on the determination unit determining that the user that checked the destination does not have the approval authority.

6. The communication apparatus according to claim 1, further comprising a request unit configured to request the user that checked the destination to input the identification information,
wherein after a request by the request unit, the acquisition unit acquires the identification information from the user that checked the destination.

7. The communication apparatus according to claim 6, further comprising an inquiry unit configured to inquire of a user whether the user checked the destination,
wherein after an inquiry by the inquiry unit, the request unit requests the user that checked the destination to input the identification information.

8. The communication apparatus according to claim 7, further comprising a prohibition unit configured to prohibit transmission of the image data until an indication that the destination was checked is provided after the inquiry by the inquiry unit.

9. The communication apparatus according to claim 1, further comprising an authentication unit configured to authenticate a user,
wherein the reception unit receives the destination from the user authenticated by the authentication unit.

10. The communication apparatus according to claim 1, further comprising a reading unit configured to read a document and generate image data,
wherein the transmission unit transmits the image data generated by the reading unit to the destination received by the reception unit based on the determination unit determining that the user that checked the destination has the approval authority.

11. A method of controlling a communication apparatus, the method comprising:
receiving a destination from a user;
acquiring identification information about a user that checked the destination;
determining whether the user that checked the destination has approval authority based on the identification information; and
transmitting image data to the destination based on the determining that the user that checked the destination has the approval authority.

12. The method according to claim 11, further comprising storing identification information about the user having the approval authority,
wherein the determining determines whether the user that checked the destination has the approval authority, based on the acquired identification information about the user and the identification information about the user which is stored in the storing.

13. The method according to claim 11, further comprising:
holding a title of a user having the approval authority; and
identifying, based on the identification information about the user which has been acquired by the acquiring, a title of the user,
wherein the determining determines whether the user that checked the destination has the approval authority based on the title identified by the identifying and the title.

14. The method according to claim 11, further comprising a displaying an error based on the determining that the user that checked the destination does not have the approval authority.

15. The method according to claim 11, further comprising requesting the user that checked the destination to input the identification information,
wherein after a request by the requesting, the acquiring acquires the identification information from the user that checked the destination.

16. A non-transitory computer-readable storage medium which stores a program for causing a computer to execute a method of controlling a communication apparatus, the program comprising:
a code to receive a destination from a user;
a code to acquire identification information about a user that checked the destination;
a code to determine whether the user that checked the destination has approval authority based on the identification information; and
a code to transmit image data to the destination based on determining that the user that checked the destination has the approval authority.

17. The non-transitory computer-readable storage medium according to claim 16, further comprising a code to store identification information about the user having the approval authority,
wherein the code to determine determines whether the user that checked the destination has the approval authority, based on the acquired identification information about the user and the stored identification information about the user.

18. The non-transitory computer-readable storage medium according to claim 16, further comprising:
a code to hold a title of a user having the approval authority; and
a code to identify, based on the acquired identification information about the user,
wherein the code to determine determines whether the user that checked the destination has the approval authority based on the identified title and the title.

19. The non-transitory computer-readable storage medium according to claim 16, further comprising a code to display an error based on the determining that the user that checked the destination does not have the approval authority.

20. The non-transitory computer-readable storage medium according to claim 16, further comprising a code to request the user that checked the destination to input the identification information,
wherein after a request by the requesting, the code to acquire acquires the identification information from the user that checked the destination.
